(19) United States
(12) Patent Application Publication
(10) Pub. No.: US 2026/0021395 A1
(43) Pub. Date: Jan. 22, 2026

(54) IN-GAME ASSISTANT FOR TEAM GAMEPLAY

(71) Applicant: Sony Interactive Entertainment Inc., Tokyo (JP)

(72) Inventors: Jason Grimm, San Mateo, CA (US); Alex Paiz, San Mateo, CA (US)

(21) Appl. No.: 18/776,133

(22) Filed: Jul. 17, 2024

(51) Int. Cl. A63F 13/54; A63F 13/215; A63F 13/533; A63F 13/5378; A63F 13/56; G06F 40/205

(52) U.S. Cl. CPC A63F 13/54; A63F 13/215; A63F 13/533; A63F 13/5378; A63F 13/56; G06F 40/205

(57) ABSTRACT

Artificial intelligence (AI) models are disclosed to provide in-game AI assistants that can execute in-game tasks for human players in conformance with audible prompts from the human players during multi-player gameplay instances. The AI assistants can therefore report in-game events to help the human players and even act as additional players within the video game, controlling their own video game characters to establish virtual teammates to help the human players advance within the video game.

### FIELD

The disclosure below relates to technically inventive, non-routine solutions that are necessarily rooted in computer technology and that produce concrete technical improvements. In particular, the disclosure below relates to generative artificial intelligence (AI) assistants to enhance multi-player video gameplay.

### BACKGROUND

Video games are becoming increasingly complex. But as recognized herein, video game platforms currently lack the technical capability to provide sufficient aid to human players to help the players beat particularly difficult modern video games. There are currently no adequate solutions to the foregoing computer-related, technological problem.

### SUMMARY

Accordingly, in one aspect an apparatus includes at least one processor system programmed with instructions to execute a video game and, while the video game is executing, receive input from a first player. The input indicates a task for a model to execute in support of team gameplay involving the first player and a second player, with the first player and the second player being on a same team. The instructions are also executable to, based on a trigger, present an audible output pursuant to the task.

In some example implementations, the at least one processor may also be programmed with instructions to, based on the input, access game engine data and present the audible output based on both the trigger and the game engine data. Also in some implementations, the model may include a large language model (LLM).

In some examples, the task may include monitoring game health for the second player and reporting when the game health goes below a threshold, with the trigger established by the game health going below the threshold. Additionally or alternatively, the task may include monitoring a member of an opposing team and reporting when the member satisfies a condition indicated in the input, with the trigger established by the member satisfying the condition. Still further, the task may include reporting a bearing to an enemy engaging the first player, with the trigger established by receipt of the input.

As another example, the task may include reporting a strategy for the first and second player's team to follow, with the first and second player's team including the first player, the second player, a third player, and a fourth player, each being different from each other and the trigger being established by receipt of the input.

As yet another example, the task may include monitoring an inventory level for a type of item in the first player's game inventory and reporting when the inventory level goes below a threshold, with the trigger established by the inventory level going below the threshold.

Also in addition to or in lieu of the foregoing, the task may include reporting a virtual world location of a third player, where the third player is different from the first and second players and where the third player plays on the same team as the first and second players as part of the team gameplay, with the trigger established yet again by receipt of the input.

In another aspect, a method includes executing a video game and, while the video game is executing, receiving input from a first player. The input indicates a task for a model to execute in support of team gameplay involving the first player and a second player, with the first player and the second player being on a same team. The method also includes, based on a trigger, presenting an output pursuant to the task.

In certain examples, the output may include an audible output, and the model may include a large language model (LLM).

In various examples, the task itself may include marking, on a game map presented to the first and second players, a location of an opponent of the first and second players, with the trigger established by receipt of the input. Additionally or alternatively, the task may include suggesting a first loadout for the first player and a second loadout for a second player, with the trigger established by receipt of the input.

Additionally, in some instances the model may establish an in-game virtual assistant that controls a first character of the video game to play the video game with the first and second players as part of the team gameplay. Here, the first player may control a second character and the second player may control a third character, with the first, second, and third characters being different from each other.

In still another aspect, an apparatus includes at least one computer readable storage medium (CRSM) that is not a transitory signal. The at least one CRSM includes instructions executable by a processor system to receive input from a first player, with the input indicating a task for the processor system to execute in support of team gameplay involving the first player and a second player in relation to a video game being played by the first and second players as a team. The instructions are also executable to access game state data for the video game and, based on the game state data, execute an in-game function in conformance with the task.

In certain cases, the instructions may be executable to present an audible output in conformance with the task, with the audible output presented in a voice of a video game character from the video game. Also in some instances, the instructions may be executable to use a deepfake generator model to generate the audible output in the voice of the video game character. If desired, the instructions may be further executable to execute a large language model (LLM) to parse the game state data and identify speech to include in the audible output.

What's more, in some cases the instructions may be executable to execute the in-game function responsive to a trigger occurring, with the trigger indicated via the input.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2-4 show illustrations of a first video game player conversing back and forth with an in-game AI assistant that executes in-game tasks while the first player engages in team gameplay consistent with present principles;

FIGS. 5 and 6 show illustrations of the first video game player conversing back and forth with the in-game AI assistant to execute in-game tasks while the first player engages in single-player gameplay consistent with present principles;

FIG. 7 shows example logic in example flow chart format that may be executed by a system/apparatus consistent with present principles;

FIG. 8 shows example AI architecture that may be implemented consistent with present principles; and

FIG. 9 shows an example settings graphical user interface (GUI) that may be used to configure one or more settings of a system/apparatus to operate consistent with present principles.

### DETAILED DESCRIPTION

The detailed description below provides technical systems and methods for implementing a computer game artificial intelligence (AI) assistant. Specifically, the AI assistant can use a large language model (LLM) to give a player responses to questions the player asks, and it can even do so in the voice of a character from the video game. The player can therefore have a constant companion that's with the player as the player progresses through the game, with the character voice helping the user stay immersed in the game itself.

Present principles may be used for team gameplay and for single-player gameplay. For team gameplay where four human players might be playing a same game instance on a same team, the AI assistant can act as a fifth player that monitors gameplay of the team of human players and also monitors for certain in-game events specified in advance by the players. For example, the AI assistant can be asked to monitor a certain teammate's health, to mark where a game enemy is located, to provide a gameplay/team strategy for the team, to tell a player where the player was shot from, and to tell a player where a teammate is located in the game world (e.g., by bearing and distance). The AI assistant can also suggest a loadout for a player and/or team. The AI assistant can also be asked to let one player know when a teammate's character is about to die in the game or to even let the requesting player know about a location of a teammate through cardinal directions. The AI assistant can also let the human players know a distance to a target or a distance to another human teammate within the game's virtual world. The AI assistant can even mark places and events on a game map, indicating that a player was hit from certain angle or marking a virtual game location with “bad guy is here” so that other players can know the angle/location in advance before traveling within the game world to that location. Also in terms of team gameplay, note that while four players were referenced above, team gameplay may involve any number of two or more human players playing on the same team to accomplish a common goal.

For single-player gameplay, the AI assistant can act as a second player that can play alongside the human (first) player. The assistant can still receive instructions from the human player and act in conformance with the instructions. For example, the human player can tell the AI assistant to “go here” or “do XYZ” and then the AI assistant can perform the corresponding in-game action in conformance with the human's request, even controlling another game character within the game to do so (thus playing the game along with the human).

Present principles may be applied to video/computer games presented on televisions and other types of stand-alone displays, and may also be applied to video games presented on headsets in extended reality, such as in augmented reality and/or virtual reality implementations.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

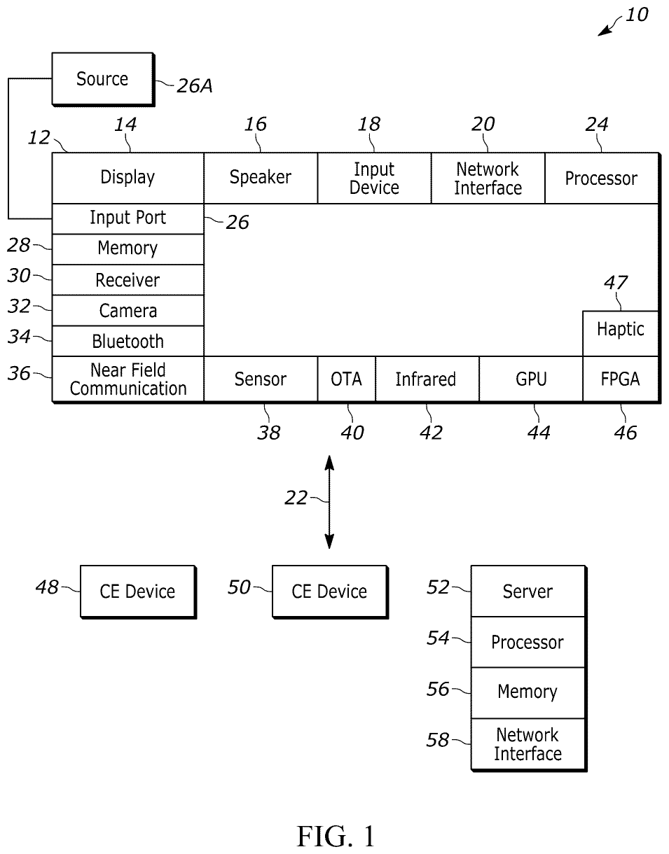

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

Also note before describing other figures that selectors and options on the GUIs discussed below may be selected via cursor input, touch input to the touch-enabled display on which the GUI is presented, using voice input, and/or using other input methods.

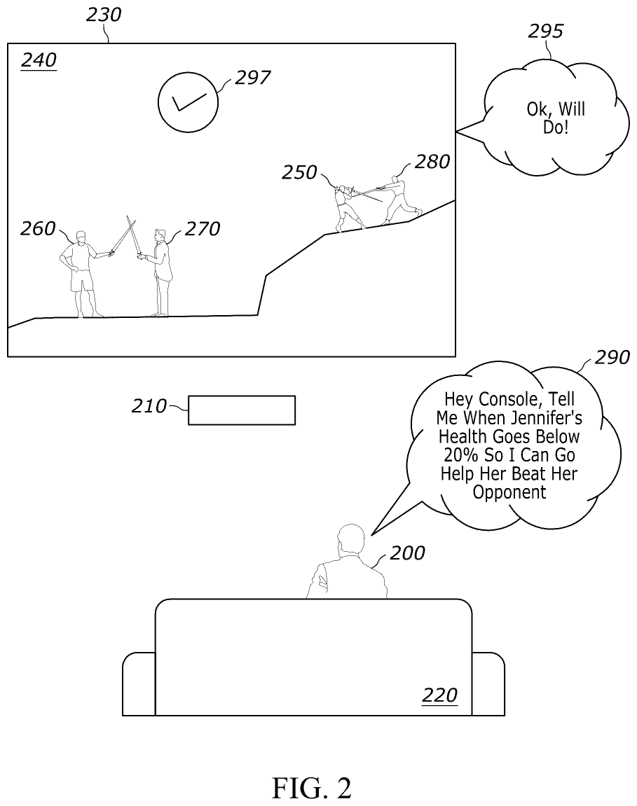

Now in reference to FIG. 2, suppose a first human player 200 and a second human player are playing a video game together. The second player is not shown in FIG. 2 because the second player is playing remotely from another location according to this example (e.g., the second player's personal residence). But as shown in FIG. 2, the first player 200 is playing the video game with the second player over a cloud/game platform network. As such, the video game may be stored at and executed by a server that forms part of the network, and/or the video game may be executed by a local console 210 at the personal residence of the first player 200.

As also shown in FIG. 2, the first player 200 is sitting on a couch 220 while playing the video game through the console 220 and/or server, with the console/server controlling a connected television display 230 to present video game video 240. Speakers on the TV display 230 may also be used to present audio from the video game as well as audio from an AI assistant as will be described in a moment.

Note per this example that as part of team gameplay involving the first and second players, the first player 200 is controlling/playing a first video game character 250 while the second player is controlling/playing a second video game character 260. Note that team gameplay itself may involve the first and second players, and potentially additional human players such as third and fourth players, playing the same game instance together as a team to one or both of: (1) accomplish a common goal in the video game, and/or (2) play against (e.g., oppose or defeat) a common enemy(s)/other team(s) in the video game. The common enemy(s) and/or other team(s) may be computer-controlled by the game engine without human input being used to control the opposing party(s), and/or more be controlled by human players playing as the opponent(s). For the purposes of this example, assume the first and second players are playing as a team against another team of computer-controlled characters that includes characters 270, 280. As such, the first player 200 is playing the character 250 to sword fight against the computer-controlled character 280, while the second player is playing the character 260 to sword fight against the computer-controlled character 270.

Also suppose that the first player 200 is somewhat more skilled than the second player and wants to help the second player if need be so that the two players can beat their opponents. Consistent with present principles, an AI-based in-game virtual assistant may execute as a background process as part of the game engine (and/or operate as part of an operating system controlling the game engine). Knowing this, the first player might trigger the in-game AI assistant with an audible wake-up phrase to cue the AI assistant to process ensuing user input. Here, the wake-up phrase includes the player 200 saying, “Hey console,” which a microphone on the console 220 (or connected device) may detect for the wake-up phrase to then be processed and recognized through speech recognition.

The player 200 can then speak the ensuing user input itself to enlist the AI assistant to help the first and second players. In the present instance, speech bubble 290 represents that the first player audibly says, “Tell me when Jennifer's health goes below 20% so I can go help her beat her opponent,” with it being understood that Jennifer is the second player. The AI assistant can then respond with an audible output by indicating, “Ok, will do!” to acknowledge the command has been received, as illustrated by speech bubble 295. The AI assistant might also present a visual output 297 on the display 230, with the output 297 being a green check mark per this example to also acknowledge that the command has been received. The output 297 may or may not be presented on the respective display being used by the second player (Jennifer) at the remote location.

The AI assistant can then use its built-in large language model (LLM) and/or other natural language processing algorithm(s) to infer the associated task the first player is assigning to the assistant through the verbal input. In the present instance, the task includes monitoring the game health for the second player and reporting when the second player's game health goes below a threshold health amount. The game health of the second player's character 260 going below the first player-specified health threshold may therefore trigger the AI assistant to notify the first player that the game health threshold has been crossed (but potentially not notify the second player through the second player's own respective gaming device/TV). Also note for completeness that once the second player's game health reaches zero, the second player's character 260 would die and/or lose a game life.

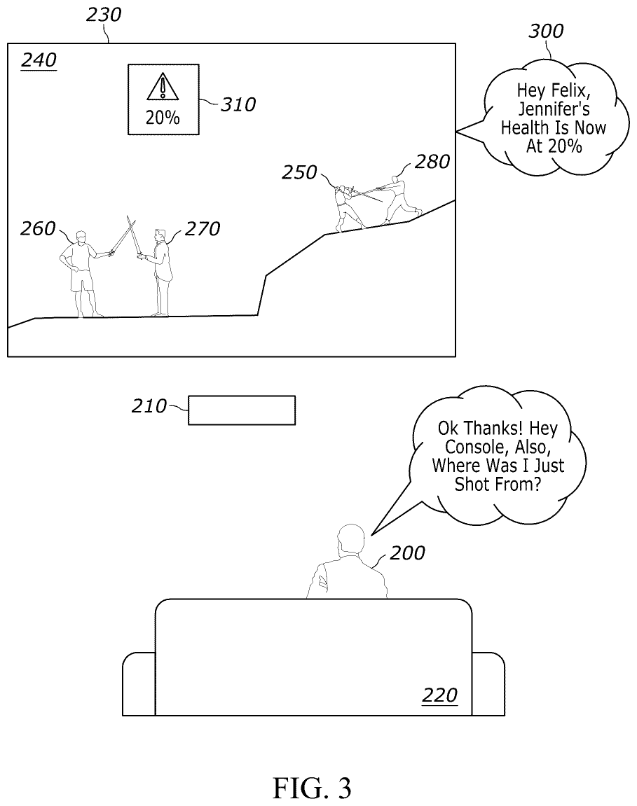

FIG. 3 then shows that as the team gameplay continues with the first and second players controlling the characters 250, 260 to battle their opponent characters 270, 280, the game health of the second player's character 260 goes below the health threshold of 20% specified by the first player. The in-game AI assistant may determine as much from data provided by the game engine that is executing the game instance being played. Responsive to the determination that the game health of the character 260 has gone below the threshold, the AI assistant may provide an audible output as represented by speech bubble 300. The audible output includes natural language indicating, “Hey Felix, Jennifer's health is now at 20%!” Note here that Felix is the first player's first name, and further note that in some instances the audible output from the AI assistant may or may not be presented on the respective local device being used by the second player to play the video game. Also note that in some instances, the AI assistant may also provide a visual output that includes a box with an exclamation point inside a triangle as well as the text “20%” to visually demonstrate to the first player 200 that the trigger specified by the first player 200 has been reached.

Upon hearing the audible output from the AI assistant, the first player 200 might then audibly respond, continuing to converse with the AI assistant. As such, in the present instance the first player 200 audibly indicates, “Ok, thanks!” to acknowledge the AI assistant's audible output.

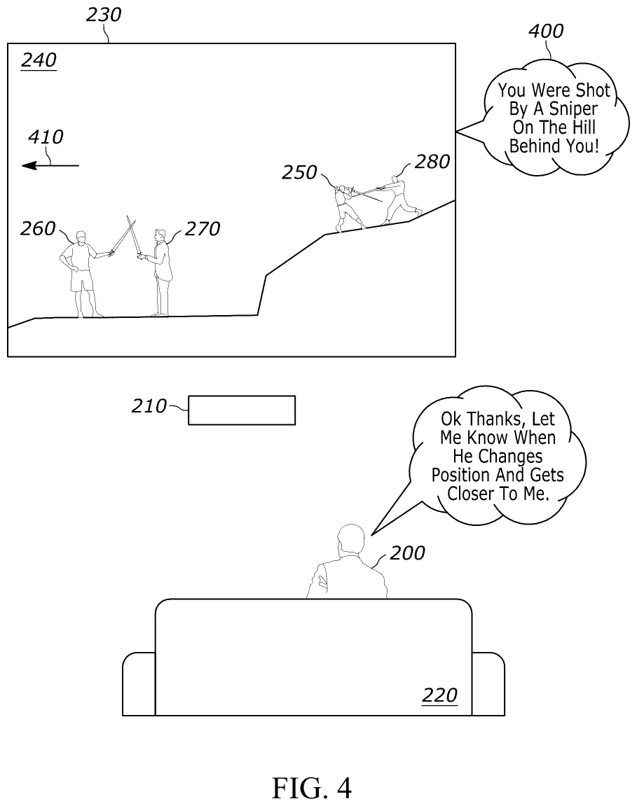

Additionally, suppose the first player's character 250 was just shot by another opponent character located offscreen. As such, the first player 200 might also audibly ask the AI assistant, “Hey console, also, where was I just shot from?” The AI assistant may then infer another task to execute based on that audible input, which in the present instance includes reporting a bearing to whatever in-game enemy is engaging (shot or otherwise attacked) the first player from offscreen. Therefore, responsive to the audible input from the player 200, the AI assistant may be triggered to immediately answer the first player's question, as represented in FIG. 4.

As shown in FIG. 4, the AI assistant may then provide an audible response as represented by speech bubble 400. The audible response indicates the bearing from which the first player's character 250 was shot. In the present instance, the audible input indicates, “You were shot by a sniper on the hill behind you.” Thus, note here that the audible output includes not just the bearing (behind the user) but also an in-game geolocation of the opponent that shot the first player's character 250 (a hill behind the character 250). Also note that the audible output from the AI assistant may be accompanied by visual output 410 in the form of a flashing arrow to indicate the bearing to further aid the first player.

Also suppose per FIG. 4 that the first player 200 acknowledges the audible output informing the first player 200 of the bearing and then audibly indicates another task for the AI assistant to execute. In the present instance, that includes the first player 200 audibly saying, “Let me know when he changes position and gets closer to me.” The AI assistant may then infer based on the context of its previous output that “he” is the in-game opponent that just shot the first player's character 250 as indicated in the AI assistant's previous output, and then infer that the new task being asked of it is monitoring that opposing team member (the enemy that shot the first player's character 250) and reporting when the opposing team member satisfies a condition indicated in the first player's audible input. Here, that condition is the opponent changing position and getting closer in the game world to the first player's character 250. Therefore, assume that responsive to the game engine data to which the AI assistant has access indicating that the opponent has changed position and has gotten closer to the first player's character 250, the AI assistant may provide yet another audible notification of that event to the first player 200.

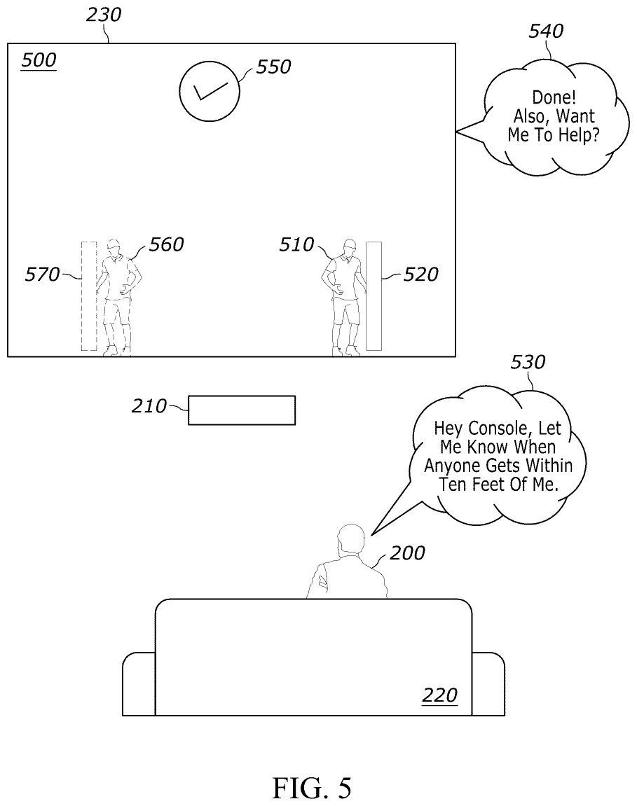

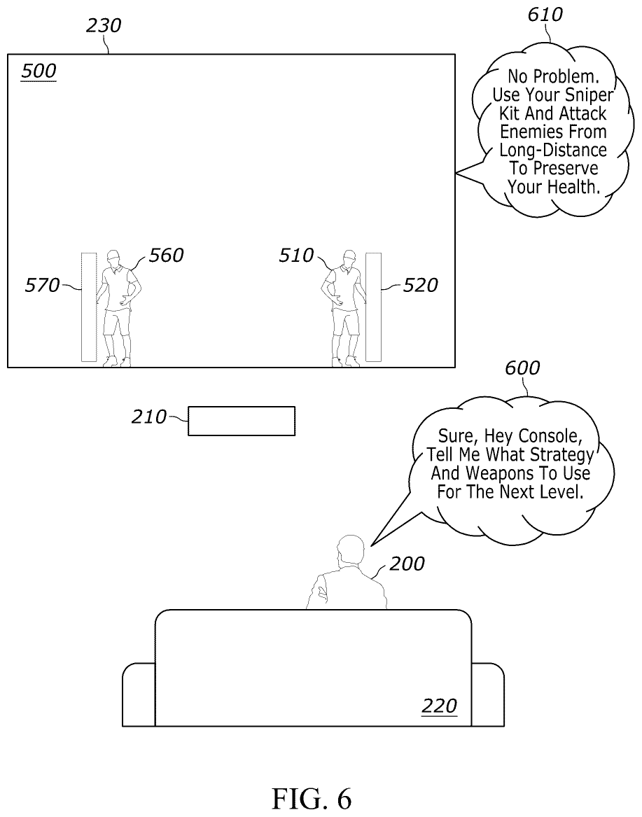

Continuing the detailed description in reference to FIGS. 5 and 6, another example will now be described but in relation to a single-player game instance. Here, suppose the first player 200 is playing a different video game through the gaming platform's network and/or local console 210. As such, video game video 500 for the second video game is being presented on the display 230 along with video game audio through the display's speakers. In contrast to the example of FIGS. 2-4 above, per this example the second video game is being executed to render a single-player game instance where the first player 200 is playing the video game by themselves without other human players playing on the same team. Yet the first player 200 might still be playing against another human player as an opponent, or might be playing the single-player game instance against a virtual opponent controlled by the game engine itself without human input. In either case, note that while the video game is executing, the AI assistant may again be running in the background to receive input from the first player 200 indicating a task for the AI assistant to execute in support of the first player 200 in the single-player game instance.

As part of the single-player game instance, assume the player 200 is controlling a video game character 510, with the character 510 carrying a two-by-four wood plank 520 for self-defense as part of the single-player game instance. Also assume the player 200 provides audible input to the AI assistant by indicating, “Hey console, let me know when anyone gets within ten feet of me,” as represented by speech bubble 530. This enlists the AI assistant as a non-player team member so that the player 200 is warned when an in-game opponent is coming in for an attack on the character 510. Thus, the AI assistant may infer that the in-game task being assigned to it is monitoring the locations of enemies/opponents of the character 510 within the game and reporting when any enemy/opponent satisfies the condition of coming within ten feet of the character 510 within the virtual game world itself.

Speech bubble 540 as also shown in FIG. 5 indicates that the AI assistant may respond to acknowledge the task being assigned to it by audibly exclaiming “Done!” To also acknowledge the assigned task, the AI assistant may also present a visual output 550 in the form of a green check mark to visually acknowledge the task as well.

The AI assistant might also, on its own volition, provide an additional audible output as also represented by the speech bubble 540, with the additional audible output asking if the first player 200 wants the AI assistant to engage in the game to help the first player 200 play the video game. The AI assistant might do so by indicating, “Also, want me to help?” and also present a visual output 560 in the form of a semi-transparent second game character 560 that is holding a second two-by-four wood plank 570. Alpha blending may therefore be used to render the character 560 and plank 570 semi-transparently, such as at 50% rather (than fully opaque) to signal to the user that the character 560 and plank 570 are being suggested by the AI assistant.

Also note that in some examples, the AI assistant might use a video game narrator voice or a dedicated AI assistant voice to present audible outputs prior to the AI assistant asking the first player 200 if the first player 200 wants some help. Then for the audible output, “Also, want me to help?” the AI assistant may switch to using a different voice that is the voice of the second character 560 itself to further denote that the AI assistant is asking whether the player 200 wants the AI assistant to control the character 560 to help the first player 200 play the single-player game instance with AI-assisted help. However, in other examples the AI assistant might use the voice of the character 560 throughout execution of the single-player game instance, including prior to presenting the audible output represented by speech bubble 540. In either case, a deepfake generator may be used to generate the voice of the character 560 to audibly indicate things dynamically on the fly based on responses inferred by the AI assistant based on whatever input the player 200 actually provides.

In terms of the second character 560 themselves, note that in various examples the character 560 may be an ally of the first character according to a plot line for the particular video game that is being played. For example, the character 560 may be an in-game friend, sidekick, or assistant of the character 510. Additionally or alternatively, the second character 560 might be a character that is also usable for team gameplay in the video game in a team gameplay mode, where the character 560 is still an ally or even an opponent of the character 510 according to the plot line.

Now in reference to FIG. 6, suppose the player 200 does in fact want the AI assistant to help the player 200 play the single-player game instance. As such, speech bubble 600 indicates that the player 200 audibly responds in the affirmative by saying, “Sure!” Responsive to the player's affirmative response, the semi-transparent presentation of the character 560 and plank 570 may be changed into a fully opaque presentation of the character 560 and plank 570 as shown in FIG. 6 to indicate that the player's response has been received and the AI assistant is now playing the game with the first player 200.

Speech bubble 600 also shows that the player 200 may then submit another prompt to the AI assistant. Here, that prompt from the player 200 includes audible input asking, “Hey console, tell me what strategy and weapons to use for the next level.” The AI assistant may then use its LLM to infer two tasks being asked of it by the player 200. The first task includes reporting a strategy for player 200 to follow, and the second task includes suggesting a weapon loadout for the player 200.

Accordingly, speech bubble 610 demonstrates the audible responses the AI assistant provides in conformance with and responsive to the player's prompt. In the present instance, the audible output indicates, “No problem. Use your sniper kit and attack enemies from long-distance to preserve your health.” It may therefore be appreciated based on this that the audible natural language output from the AI assistant blends the outputs for the two different tasks into a single statement that both provides a gameplay strategy (attack enemies from long-distance to preserve character health) and a suggested loadout (a sniper rifle kit that includes a sniper rifle, scope, and ammo).

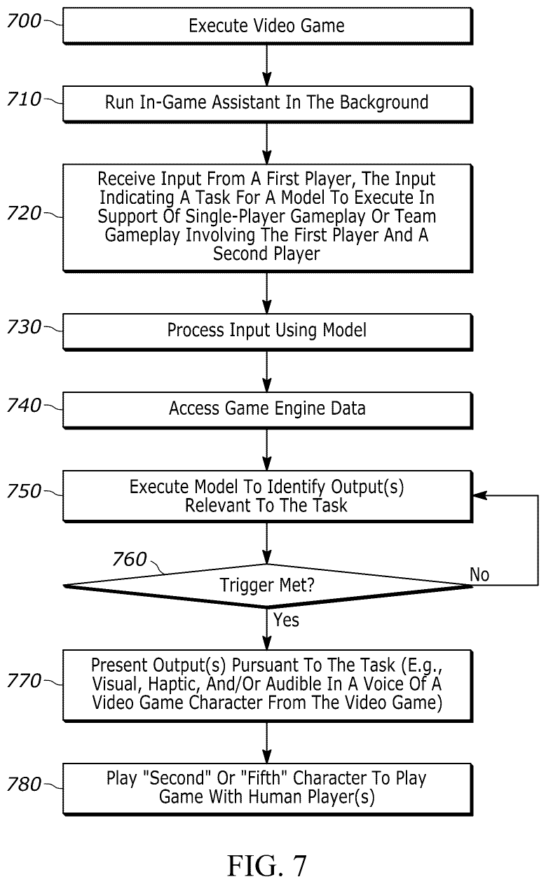

Now in reference to FIG. 7, this figure shows example logic that may be executed by an apparatus such as the CE device 12 (e.g., console) and/or game platform server 52 alone or in any appropriate combination. Thus, in some examples the logic may be executed by a client device alone. In other examples, the logic may be executed by a client device and remotely-located server, where the client device offloads some or all of the logic to the server. Further note that while the logic of FIG. 7 is shown in flow chart format, other suitable logic may also be used.

Beginning at block 700, the apparatus may execute a video game. For example, at block 700 the apparatus may execute a single-player game instance or multi-player team gameplay instance for a video game selected by a first player. The logic may then move to block 710 where the apparatus may run an in-game AI assistant (AI model) consistent with present principles as a background process while the first player plays the video game.

The logic may then proceed to block 720. At block 720 the apparatus may, while the video game is executing, receive input from the first player via a microphone connected to the apparatus. The input may indicate a task for the AI model to execute in support of the single-player or team gameplay (the team gameplay involving the first player and at least a second player on the same team). From block 720 the logic may then proceed to block 730.

At block 730 the AI model may use a large language model (LLM) embodied as part of the AI model to process the input from the first player and infer a task being asked of the AI model by the first player. With the task(s) identified, the logic may then proceed to block 740 where the apparatus may access game engine data provided by the game engine that is being used to present the single-player or multi-player game instance. The AI assistant may then parse the available game state data and identify particular game state data to use and/or provide in conformance with the task. Thus, at block 750 the apparatus may execute the AI model to identify relevant outputs pursuant to the task being asked by the first player.

The logic may then proceed to decision diamond 760 to determine whether the trigger for providing the identified output has been met. The trigger might be the audible input itself, if the AI model infers that an immediate response is appropriate pursuant to the first player's input. Or the trigger might be a certain in-game event or condition occurring as specified in the first player's input itself. Other triggers may also be used.

A negative determination at diamond 760 may cause the logic to revert back to block 750 to provide the relevant output at a later time responsive to the trigger ultimately being met. Then responsive to an affirmative determination at diamond 760 that the trigger has in fact been met, the logic may proceed to block 770. At block 770 the AI model may be executed to, based on the input received at block 720 and the game engine data accessed at block 740, present an audible output based on both the trigger for providing the output and the game engine data itself. Visual output and even tactile/haptic output may also be presented at block 770.

In terms of the audible output provided at block 770, note again that the output may be provided in a voice of a video game character from the video game that is being executed. The visual output(s) that are presented at block 770 may complement the audible output and might be any of the visual outputs discussed above in reference to FIGS. 2-6. Regarding the tactile outputs, a vibrator like the generator 47 mentioned above in reference to FIG. 1 may be used, as embodied in a video game controller being used/controlled by the first player to play the video game. Vibrations may therefore be generated at the controller as a long, continuous vibration or even a few short vibrations in a row to signify to the first player that something has occurred in the game pursuant to the first player's audible input (e.g., a teammate's character health has gone below a health threshold).

From block 770 the logic may then proceed to block 780. At block 780 the AI model may play the single-player or multi-player game instance with the human player(s) (e.g., if authorized by one of the human players). Thus, for a single-player game instance, the AI model may engage in the game as a non-human player team member using a second character to help the human player play the video game. For a multi-player game instance, the AI model may engage in the game as a non-human player team member using a character not used by any of the human players in the same game instance to thus help the human players play the video game. So if four human players are playing as a team using four respective game characters, the AI model may play as a fifth player as part of the team's joint gameplay toward a common goal, controlling a fifth character of the video game not used by the human players to play the game with the human players, with each of the five human/non-human players using a different game character.

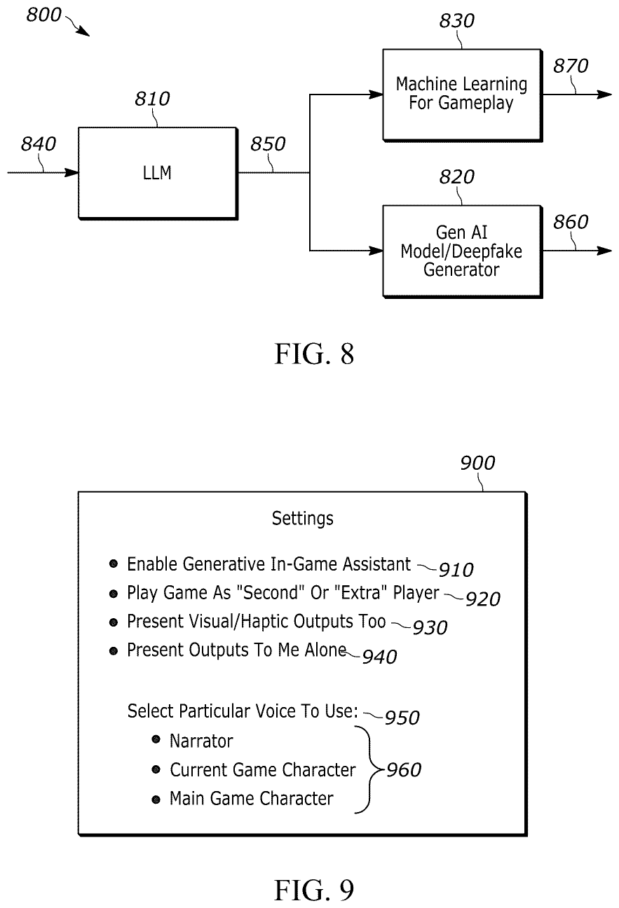

Turning now to FIG. 8, example artificial intelligence (AI) model architecture 800 is shown that may be implemented in an apparatus consistent with present principles. The architecture 800 may be constructed with a first model 810 that includes one or more large language models (LLMs), generative pretrained transformers, and/or other machine learning-based models for identifying relevant in-game tasks to execute based on voice prompts or other types of prompts from the player (e.g., text prompts provided via a keyboard). Thus, in addition to or in lieu of an LLM, the model 810 may be established by one or more deep neural networks (NNs), such as one or more convolutional neural networks (CNNs) in particular. The LLM, CNN, and/or other AI-based model 810 may be trained to make inferences of relevant in-game tasks to execute based on current game state data for a video game being played by the player as well voice prompts from the player themselves. So, for example, the model 810 may be trained in supervised fashion using a dataset that includes respective pairs of game engine data and voice prompts along with accompanying ground truth labels for each pair indicating the associated in-game tasks to execute. Unsupervised learning, semi-supervised learning, reinforcement learning, and other learning techniques may additionally or alternatively be used to train the model 810.

FIG. 8 also shows that the architecture 800 may include a second model 820 that is different from the first model 810. The second model 820 may be a generative AI model such as a deepfake generator or other audio generation model. The first LLM/model 810 might therefore output a text-based inference for the model 820 to then convert the text into audio using a text-to-speech algorithm for the generated audio to then be read/spoken aloud in the voice of a character from the video game played by the player. The deepfake generator may therefore be trained to generate deepfake audio in the voice of different video game characters from different games. As an example, the generator may be provided audio clips of different video games, with each clip containing audio of a particular game character speaking. Each clip may have a label attached that indicates the name of the associated character speaking in the associated clip. The deepfake generator may then be trained using the clip/label pairs in supervised fashion to configure the deepfake generator to generate other audio for a given character that includes different words never spoken by the character in the original game content itself but that respond to a player's audible input.

The AI architecture 800 may also include a third model 830. The third model 830 may be a machine learning-based gameplay model that has been trained through reinforcement learning to play a given video game or even multiple video games. The third model 830 may therefore be trained by playing the game(s) itself, with the model 830 being given positive reinforcements for game actions the model 830 performs that advance the model's character within the game. The model 830 may also be given negative reinforcements for game actions the model 830 performs that impede the character from advancement within the game. In this way, the model 830 may be trained to act as a “second” or “fifth” player in a game along with human players consistent with the description above.

Describing an example use of the architecture 800 during deployment, note that an audible prompt 840 from a user may be fed into the first model 810 as input. The first model 810 may then determine an output 850 in conformance with a task indicated in the prompt based on correlations/inferences made by the model 810 using current game state data. If the inferred output 850 is to provide an audible response with certain game information as requested by the player, the model 800 may provide the output 850 to the deepfake generator 820 to present audible output 860 in the voice of a video game character from the video game itself. If the inferred output 850 is for the AI assistant to play the video game itself (and/or take other in-game actions in addition to or in lieu of providing an audible output to the human player), the model 800 may provide the output 850 to the machine learning-based model 830 that has already been trained through reinforcement learning to play the video game for the model 830 to issue control commands 870 to be provided to the game engine for the AI assistant to play the video game. Also note that in some examples, outputs 850 from the LLM 810 may be provided to both the model 820 and the model 830 in tandem for the architecture 800 to act in conformance with the human player's input/audible prompt 840 by both providing an audible response 860 and issuing control commands 870 to the game engine to perform an in-game action(s).

Continuing the detailed description in reference to FIG. 9, it shows an example GUI 900 that may be presented on a display for an end-user to configure one or more settings of an apparatus to operate consistent with present principles. The GUI 900 may be presented as part of a console operating system settings screen or video game settings screen, for example.

As shown in FIG. 9, the GUI 900 may include a first option 910 that is selectable to command the apparatus to enable/turn on a generative in-game AI assistant to act in accordance with human player commands consistent with the description of FIGS. 2-8 above. Therefore, the option 910 may be selected a single time to set or configure the apparatus to, for multiple future game instances, undertake one or more of the actions described above in reference to FIGS. 2-8.

The GUI 900 may also include an option 920. The option 920 may be selectable to specifically set or enable the apparatus to play video games with human players as a second or extra player, using a different game character than the human players themselves, as discussed above.

If desired, the GUI 900 may also include options 930 and 940. The option 930 may be selectable to set or enable the apparatus to also present visual and/or haptic outputs in addition to audible responses to human player prompts. The option 940 may be selectable to set or enable the apparatus to present audible, visual, and/or tactile outputs to the requesting player alone, rather than presenting the outputs to all players who might be playing together in a multi-player team gameplay instance. So, for example, selection of the option 940 may configure the apparatus to report on the health level of other players and a bearing to an enemy that just shot at the requesting player at that player's individual gaming device alone, declining to not present the same outputs to other players on the same team who might be playing remotely from the user as part of the same game instance.

The GUI 900 may further include a setting 950 at which the user can select a particular character voice in which audible output from the in-game AI assistant should be presented. Respectively selectable options 960 may therefore be presented as part of the GUI 900 for the player to select the game narrator's voice, a current game character's voice, or a different main character's voice for the AI assistant to use for its audible outputs.

Moving on from FIG. 9, note with respect to the principles set forth herein that features described in reference to a multi-player game instance can be used for a single player game instance, and vice versa. For example, game strategies and loadouts may be provided to members of a team in a multi-player game instance, and health threshold notifications and bearings to in-game enemies that have shot at a human player's character can be provided in single-player game instances. With the foregoing in mind, additional examples will now be provided consistent with present principles.

As a first example, a task for the AI assistant to execute might include reporting a strategy for a team of four human players to follow. The strategy might relate to beating a particular in-game adversary (e.g., game boss), beating a particular level, or even an overall strategy for beating the entire game as a whole.

As another example, a task for the AI assistant to execute in team gameplay may include suggesting a first loadout for the first player and a second loadout for a second player. The loadout may include inventory items to load for a given level, whether those inventory items are player lives, health boosts, virtual currency, weapons and ammo to use, etc. The loadouts may be determined by the AI assistant based on game engine data indicating different skills and assets that might be used for a given level, for instance. Loadouts may also be suggested based on a history of past gameplay instances by others, where the history is parsed to infer loadouts that were more effective than others in beating that same level of the video game to then suggest the more-effective loadouts to others.

As another example, again for team gameplay, a task for the AI assistant to execute may include monitoring an inventory level for a type of item in a given player's game inventory and reporting to that player when the inventory level goes below a threshold (the reporting trigger here being established by the inventory level going below the threshold). The inventory level might relate to health potion level, player lives level, ammo level, virtual currency level, etc.

As yet another example for team gameplay, a task for the AI assistant to execute may include reporting a virtual world location of another player playing on the same team as a first human player that requested the reporting of the location. So, for example, the initial player might say something like, “Hey console, where is my teammate Jorge?” and the AI assistant may provide an audible response indicating where in the virtual game world, virtual geo-location wise, Jorge is located.

Providing another example for team gameplay, a task for the AI assistant to execute may include marking, on a game map presented to the first and second players via their respective displays (e.g., in a top right corner of video game video), a location of an opponent of the first and second players or even a teammate of the first and second players. The game map might be a map of the game world in which the video game takes place, a map of a particular level of the video game, or a map of another virtual geographic area through which the players may navigate their characters as part of the gameplay.

Switching to examples for single-player gameplay, again reiterating that all examples may be used for both team gameplay and single-player gameplay, a task for the AI assistant to execute may include monitoring game health of a character controlled by the single player and reporting when the game health goes below a threshold.

As another example for single-player gameplay, a task for the AI assistant to execute may include monitoring an in-game enemy of a character controlled by the single player and reporting when the in-game enemy satisfies a condition indicated in the input. The condition might be the enemy coming within a threshold virtual distance of the player's character within the game world, the enemy gaining a certain type of power that could be used against the player, the enemy switching to a certain weapon, the enemy accomplishing something within the game, etc.

As yet another example for single-player gameplay, a task for the AI assistant to execute may include reporting to the single player a game world location from which a character controlled by the single player was attacked. The game world location might be a virtual landmark location, a game map location, etc.

It may now be appreciated that present principles provide an in-game AI assistant that can provide relevant game content and even play the game with human players live in real-time to act as a virtual teammate for the human player(s). The AI assistant can provide responses to questions the player asks about the game, and the AI assistant can accompany the player through the entire game as the player plays the game and provide customized outputs and even in-game actions to assist the human player(s).

While the particular embodiments are herein shown and described in detail, it is to be understood that the subject matter which is encompassed by the present application is limited only by the claims.

What is claimed is:

1. An apparatus, comprising:
at least one processor system programmed with instructions to:
execute a video game;
while the video game is executing, receive input from a first player, the input indicating a task for a model to execute in support of team gameplay involving the first player and a second player, the first player and the second player being on a same team; and
based on a trigger, present an audible output pursuant to the task.

2. The apparatus of claim 1, wherein the at least one processor is programmed with instructions to:
based on the input, access game engine data and present the audible output based on both the trigger and the game engine data.

3. The apparatus of claim 1, wherein the task comprises monitoring game health for the second player and reporting when the game health goes below a threshold, the trigger established by the game health going below the threshold.

4. The apparatus of claim 1, wherein the task comprises monitoring a member of an opposing team and reporting when the member satisfies a condition indicated in the input, the trigger established by the member satisfying the condition.

5. The apparatus of claim 1, wherein the task comprises reporting a bearing to an enemy engaging the first player, the trigger established by receipt of the input.

6. The apparatus of claim 1, wherein the task comprises reporting a strategy for the first and second player's team to follow, the first and second player's team comprising the first player, the second player, a third player, and a fourth player, the first, second, third, and fourth players being different from each other, the trigger established by receipt of the input.

7. The apparatus of claim 1, wherein the task comprises monitoring an inventory level for a type of item in the first player's game inventory and reporting when the inventory level goes below a threshold, the trigger established by the inventory level going below the threshold.

8. The apparatus of claim 1, wherein the task comprises reporting a virtual world location of a third player, the third player being different from the first and second players, the third player playing on the same team as the first and second players as part of the team gameplay, the trigger established by receipt of the input.

9. The apparatus of claim 1, wherein the model comprises a large language model (LLM).

10. A method, comprising:
executing a video game;
while the video game is executing, receiving input from a first player, the input indicating a task for a model to execute in support of team gameplay involving the first player and a second player, the first player and the second player being on a same team; and
based on a trigger, presenting an output pursuant to the task.

11. The method of claim 10, wherein the output comprises an audible output.

12. The method of claim 10, wherein the task comprises marking, on a game map presented to the first and second players, a location of an opponent of the first and second players, the trigger established by receipt of the input.

13. The method of claim 10, wherein the task comprises suggesting a first loadout for the first player and a second loadout for a second player, the trigger established by receipt of the input.

14. The method of claim 10, wherein the model establishes an in-game virtual assistant that controls a first character of the video game to play the video game with the first and second players as part of the team gameplay, the first player controlling a second character and the second player controlling a third character, the first, second, and third characters being different from each other.

15. The method of claim 10, wherein the model comprises a large language model (LLM).

16. An apparatus, comprising:
at least one computer readable storage medium (CRSM) that is not a transitory signal, the at least one CRSM comprising instructions executable by a processor system to:
receive input from a first player, the input indicating a task for the processor system to execute in support of team gameplay involving the first player and a second player in relation to a video game being played by the first and second players as a team;
access game state data for the video game; and
based on the game state data, execute an in-game function in conformance with the task.

17. The apparatus of claim 16, wherein the instructions are executable to:
present an audible output in conformance with the task, the audible output presented in a voice of a video game character from the video game.

18. The apparatus of claim 17, wherein the instructions are executable to:
use a deepfake generator model to generate the audible output in the voice of the video game character.

19. The apparatus of claim 18, wherein the instructions are executable to:
execute a large language model (LLM) to parse the game state data and identify speech to include in the audible output.

20. The apparatus of claim 16, wherein the instructions are executable to:
execute the in-game function responsive to a trigger occurring, the trigger indicated via the input.
